(19) United States
(12) Patent Application Publication
(10) Pub. No.: US 2010/0042409 A1
(43) Pub. Date: Feb. 18, 2010

(54) AUTOMATED VOICE SYSTEM AND METHOD

(76) Inventors: Harold Hutchinson, Charlottetown (CA); Mike Marsh, Beaverbank (CA); William McMaster, Charlottetown (CA)

Correspondence Address: BERESKIN AND PARR LLP/S.E.N.C.R.L., s.r.l., 40 KING STREET WEST, BOX 401, TORONTO, ON, M5H 3Y2, CA

(21) Appl. No.: 12/190,643

(22) Filed: Aug. 13, 2008

(51) Int. Cl. G10L 15/26

(52) U.S. Cl. 704/235; 704/E15.043

(57) ABSTRACT

A voice browser for use in a customer interaction management system for interacting with a customer, based on data contained in one or more generic knowledge trees. The system can traverse the knowledge tree based on customer responses to presented questions until a leaf node of the knowledge tree is reached. The information contained in the leaf node is then presented to the customer.

### FIELD OF THE INVENTION

This invention relates to customer interaction management systems and methods and, in particular, to a knowledge tree-based automated voice customer interaction management system and method.

### BACKGROUND OF THE INVENTION

Hierarchical knowledge trees form a part of many CRM/CIM (Customer Relationship Management/Customer Interaction Management) software products used by customer contact centers. Typically, a knowledge tree is a hierarchical data structure implemented on a database. Such a knowledge tree would normally include a root node, multiple non-leaf nodes, and multiple leaf nodes which store information to be presented to the customer, such as potential solutions to customer problems. When a customer contacts the center with a particular problem, the knowledge tree may be traversed, starting from the root node, by asking relevant questions to the customer and navigating the knowledge tree based on the customer's responses until a leaf node is reached. The leaf node reached typically contains relevant information such as the most probable solution to the customer's problem.

The process of traversing the knowledge tree is often performed with the use of a web browser. In this case, an agent with access to the web browser application would convey the appropriate questions to the consumer and input the responses. When a leaf node is reached, the agent would convey the information contained in the leaf node to the customer. Alternatively, the customer may be given direct access to a web browser application which permits the customer to navigate the knowledge tree without the help of an agent.

Customer interaction may also occur using automated voice systems, sometimes called Interactive Voice Response (IVR) systems. These systems allow customers who may not be comfortable with web browser applications to access information from the knowledge tree without the need for an agent. Typically, a customer will dial a number which is answered by the IVR system. The IVR system will then execute an application which uses prerecorded audio files to explain the options available to the user. The customer is then given the choice to select options using dual-tone multi-frequency (DTMF) key presses or spoken language. This requires a dedicated database of prerecorded audio files specifically designed for the particular IVR system.

A typical IVR system cannot use a knowledge tree designed for a web based system. This can only be accomplished through the re-keying of the data contained in the knowledge tree used by the web-based system and sometimes through the extraction and uploading of data, where possible, into the IVR system. The voice-based system requires separate setup and extensive configuration. Furthermore, if a web-based and voice-based system are to be used in tandem, each system would require separate maintenance and updating of knowledge tree data for the two separate systems.

### SUMMARY OF THE INVENTION

The embodiments of the system described herein use a generic knowledge tree, which need not have been designed specifically for a voice-based system, to interact with a customer in a voice-based format. The embodiments of the system will dynamically search through the generic knowledge tree for the appropriate information, configure that information in a format appropriate for voice-based interaction and convert the information into a verbal response to be presented to the customer.

The invention provides, in one aspect, a voice-based customer interaction system for interacting with a customer based on data contained in one or more knowledge trees, the system comprising:

a) a tree traversal module adapted to query the one or more knowledge trees for requested data;

b) a knowledge tree parser adapted to transform the requested data according to one or more business logic rules;

c) a language interpreter adapted to convert the transformed data into a text stream; and

d) a voice presentation module adapted to verbally present the text stream to the customer and accept a customer response,

wherein, the data contained in the one or more knowledge trees is not stored as audio data.

In another aspect, the invention provides a method of interacting with a customer using automated voice communication, the method comprising:

a) querying one or more knowledge trees for requested data;

b) transforming the requested data according to one or more business logic rules;

c) converting the transformed data into a text stream;

d) presenting the text stream to the customer using voice communication;

e) receiving a response from the customer;

f) repeating steps a) to e) until a leaf node of the one or more knowledge trees is reached at step a); and

g) presenting information contained in the leaf node to the customer using voice communication

wherein, the data contained in the one or more knowledge trees is not stored as audio data.

In another aspect, the invention provides a customer interaction system, the system comprising:

a) a database adapted for storing one or more generic knowledge trees;

b) a web-based customer interaction system adapted for interacting with a customer via the Internet based on data contained in the one or more knowledge trees; and

c) a voice-based customer interaction system adapted for interacting with a customer using automated voice communication based on data contained in the one or more knowledge trees, the system comprising:
i) a tree traversal module adapted to query the one or more knowledge trees for requested data;
ii) a knowledge tree parser adapted to transform the requested data according to one or more business logic rules;
iii) a language interpreter adapted to convert the transformed data into a text stream;
iv) a voice presentation module adapted to verbally present the text stream to the customer and accept a customer response.

### BRIEF DESCRIPTION OF THE DRAWINGS

For a better understanding of the present invention, and to show more clearly how it may be carried into effect, reference will now be made by way of example, to the accompanying drawings that show embodiments of the present invention.

FIG. 1 is a block diagram illustrating an exemplary customer interaction system according to an embodiment of the present invention;

FIG. 2 shows an exemplary generic knowledge tree data structure;

FIG. 3 is a block diagram of an exemplary voice browser module contained in the customer interaction system of FIG. 1; and

FIG. 4 is a flowchart illustrating an exemplary method of operation of the customer interaction system of FIG. 1.

For simplicity and clarity of illustration, elements shown in the figures have not necessarily been drawn to scale. Further, where considered appropriate, reference numerals may be repeated among the figures to indicate corresponding or analogous elements.

### DETAILED DESCRIPTION OF THE INVENTION

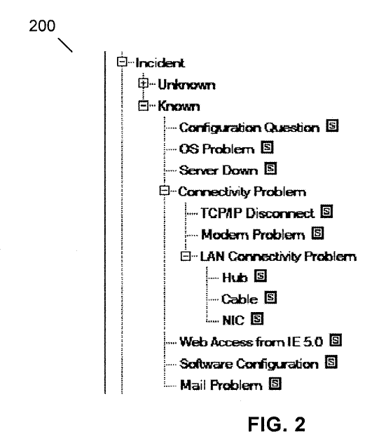

Referring first to FIG. 2, a simplified exemplary generic knowledge tree data structure 200 is shown. The knowledge tree can be considered generic because it has not necessarily been designed for any particular type of system. In particular, it does not contain pre-recorded audio files for use in a voice-based system nor has the data been structured with a voice-based system in mind. The same generic knowledge tree could potentially be used for a web-based, voice-based or any number of other types of customer interaction systems.

The knowledge tree preferably contains all of the information which may need to be conveyed to a customer, such as potential solutions to a customer problem. The knowledge tree contains a root node at which the customer interaction will begin. In this case, the root node is marked “Incident” indicating that this knowledge tree is used when a customer has an incident for which they require a solution. The ‘Incident’ root node has two child nodes: ‘Known’ and ‘Unknown’. Each of these non-leaf nodes in turn have multiple child nodes. In this example, leaf nodes are marked with a letter [S] indicating that a potential solution exists for that node.

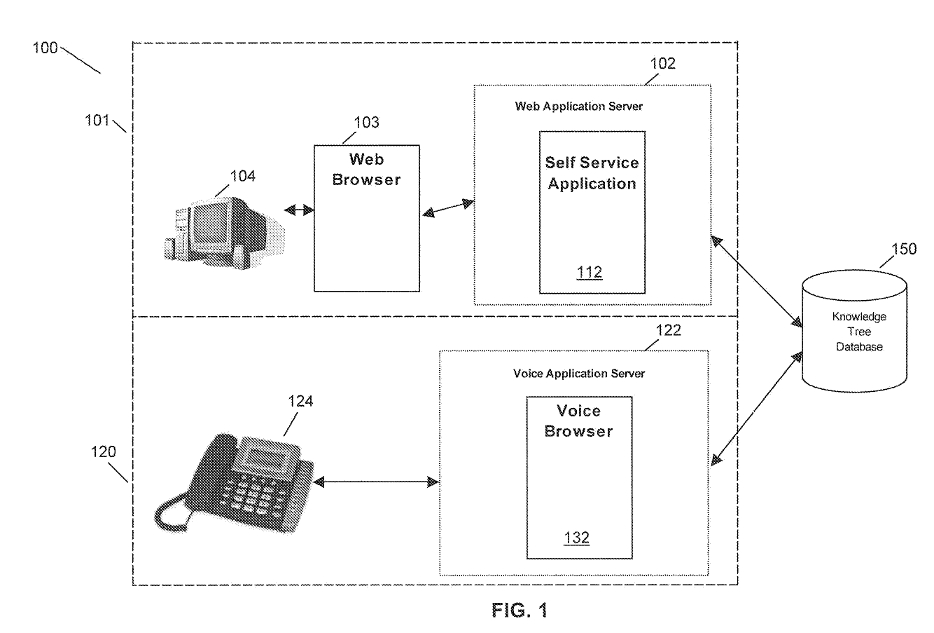

Reference is now made to FIG. 1, in which a diagram of an exemplary interaction system 100 according to an embodiment of the present invention is shown. The system 100 includes a data store for storing knowledge trees, such as database 150, and two customer interaction sub-systems: a web-based customer interaction subsystem 101 and a voice-based customer interaction subsystem 120. The web based customer interaction subsystem 101 includes a web application server 102, a web browser 103 and a client device 104 capable of running the web browser 103 such as a personal computer, laptop computer or handheld computing device. The voice based customer interaction subsystem 120 includes a voice application server 122 and a voice communication device 124, such as a telephone or personal computer with voice capabilities.

The database 150 contains one or more generic knowledge trees which may be similar to the exemplary generic knowledge tree 200 of FIG. 2. The information stored in the knowledge tree may be stored in a web browser readable format such as HTML or XML. Although for clarity, the database 150 described herein contains one knowledge tree, it will be understood by those skilled in the art that database 150 could contain, and the interaction system 100 could use, any suitable number of knowledge trees.

The web application server 102 preferably includes a self service application 112. The self service application 112 determines which node of the knowledge tree is to be visited next and retrieves the appropriate information from the knowledge tree. The self service application 112 converts information received from the knowledge tree into the form in which it will be presented to the customer, for example into a question with options which may be selected by the customer. Each option may be presented to the customer along with a check box or some other means for the customer to select an option through the web browser. The web browser 103 running on the client device 104 may present the converted information to the customer and receive the customer's response, where appropriate.

The voice application server 122 of the voice-based customer interaction subsystem 120 contains a voice browser module 132. The voice browser module can query the knowledge tree for information associated with a particular node and pass the appropriate information to the voice browser module 132.

The voice application server 122 need not have any knowledge of the information contained in the knowledge tree prior to use. A new knowledge tree may be introduced without any re-configuration of the voice application server 122 simply by entering the location of the desired knowledge tree into the voice application server 122. As the knowledge tree is generic, the same knowledge tree may be used for both the web-based and voice-based systems.

The voice browser module 132 uses information received from the knowledge tree to create a voice message. The voice communications device 124 can convey the voice message to the customer. The customer may respond to the voice message through the communications device using, for example, a dual-tone multi-frequency (DTMF) key press or other manual entry or a word or phrase spoken by the customer.

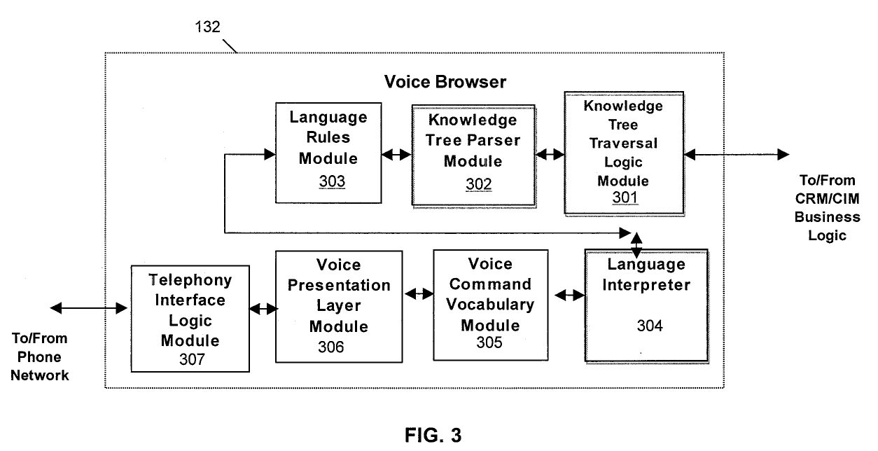

FIG. 3 shows the components in an exemplary voice browser module 132 according to an embodiment of the present invention. The voice browser module 132 includes a knowledge tree traversal logic module 301, a knowledge tree parser module 302, a language rules module 303, a language interpreter 304, a voice command vocabulary module 305, a voice presentation layer module 306 and a telephony interface logic module 307.

The knowledge tree traversal logic module 301 can traverse and query a knowledge tree. For example, the knowledge tree traversal logic module 301 can retrieve all child nodes and associated data, such as formatting information, for any particular node. For example, for the Incident/Known node of the exemplary knowledge tree 200 shown in FIG. 2, the tree traversal logic module would return the following list, along with any associated data:
Configuration Question;
OS Problem;
Server Down;
Connectivity Problem;
Web Access from IE 5.0;
Software Configuration; and
Mail Problem.
   This may be done using an SQL query or any other process which allows for data to be extracted from a database. The knowledge tree traversal logic module 301 need not have any knowledge of the structure of the knowledge tree in use in order to perform these functions.

As the generic knowledge tree need not have been designed for use in a voice-based system, the information retrieved from the knowledge tree may not be in a form appropriate for voice-based presentation. The knowledge tree parser module 302 can parse the information received from the knowledge tree traversal logic module 301 and make logical decisions about the best approach for presenting the information to the customer in a voice-based format. For example, the parser may check the returned data against a set of business logic rules to determine if the information can be presented within the boundaries of a list presentation limit which sets the maximum size for a list which is to be presented to the customer. For example, some nodes may have in excess of ten child nodes. The verbal presentation to a customer of more than ten options may not be appropriate since the customer may have a difficult time remembering all the available options when making a selection. The knowledge tree parser module 302 can make decisions about how to break the information received from the knowledge tree traversal logic module 301 into manageable chunks which may be presented to the customer.

The language rules module 303 checks that the language of the information retrieved from the knowledge tree is supported by the spoken language interpreter in the voice presentation layer module 306. If the language of the information is not supported then an error code would be generated. The voice-based customer interaction subsystem 120 would then to respond with an appropriate error handling routine or revert to a default language such as English.

The language interpreter 304 interprets the information received from the language rules module 303 into an appropriate text stream. All formatting information, such as HTML formatting and other information which may have been relevant for other types of systems, such as visual presentation data for a web-based format, is converted into appropriate spoken descriptions. The language interpreter 304 produces whole logical sentences and descriptions from basic tree branch structures. The end result is a text stream which is appropriate for the information being described.

For example, given the list of child nodes associated with the Incident/Known node in the knowledge tree 200 of FIG. 2, the web-based customer interaction subsystem 101 may have offered a category with six multiple sub choices which would appear obvious on a text based screen but which would make little sense to the customer if read back literally:
1) A Configuration Question;
2) An OS Problem;
3) A Server Down;
4) A Connectivity Problem;
5) A Web Access from IE 5.0;
6) A Software Configuration; or
7) A Mail Problem?

Given the same list of child nodes associated with the Incident/Known node in the knowledge tree 200 of FIG. 2, the language interpreter 304 could create a spoken language multiple choice question to be verbally presented to the customer, such as:
“There are 7 known incidents which might be appropriate. Would you say that you were experiencing:
   1) A Configuration Question;
   2) An OS Problem;
   3) A Server Down;
   4) A Connectivity Problem;
   5) A Web Access from IE 5.0;
   6) A Software Configuration; or
   7) A Mail Problem?
Please respond by either repeating the name of the problem you are experiencing or by pressing the number on your telephone keypad associated with the problem type.”

More than one multiple choice question may need to be created where the size of the list of child nodes exceeds the list presentation limits described above.

The voice command vocabulary module 305 provides the voice browser 132 with key command words, operators, associated logic and syntax necessary to verbally interact with the customer. The voice command vocabulary module 305 includes the voice exception process which handles situations which are not part of a command response or part of interpreted tree information. Any time a verbal response is required, but the process step is outside of the routine logic, the voice exception process takes over and delivers an appropriate response based upon the state value of any number of semaphores.

For example, the voice exception process will handle the initial greeting presented to the customer. Greetings are not stored in the knowledge tree and are not part of a tree interaction. The voice exception process also includes error handling routines to handle error conditions, such as when the language of the information retrieved from the knowledge tree is not supported, as described above.

The text stream produced by the language interpreter 304 or created by the voice command vocabulary module 305 is processed by the voice presentation layer module 306. The voice presentation layer module 306 may comprise a collection of standard speech components, such as Microsoft Speech Server™, which enables it to speak the text streams presented to it by the language interpreter 304 or by the voice command vocabulary module 305 as part of the voice exception process.

The text stream produced by the language interpreter is presented to the customer using the telephony interface logic module 307. The telephony interface logic module 307 is also responsible for handling the initial inbound customer communication (i.e. taking the virtual phone off the hook). The telephony interface logic module 307 may comprise, for example, a Dialogic telephony interface card and a Telephony Interface Manager or an IP Media Gateway. The telephony interface logic module 307 may be implemented using hardware with associated API software. It may be tightly coupled to Microsoft's Speech Server™ (i.e. it may call Microsoft's Speech Server™ routines directly as opposed to through an abstraction layer).

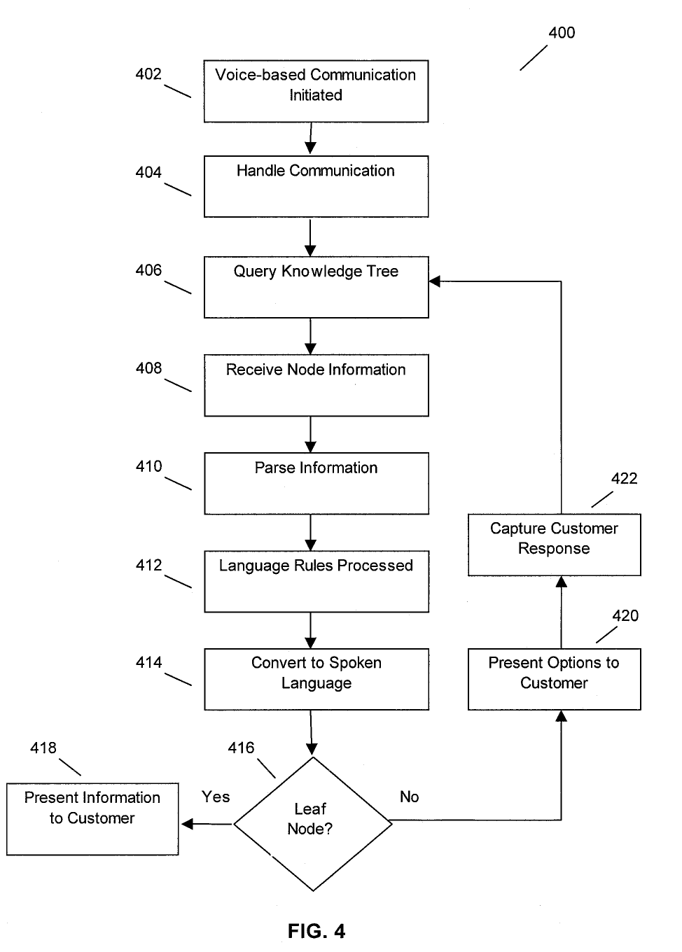

Referring now to FIG. 4, there is shown a flowchart diagram of an exemplary automated voice customer interaction method 400 according to an embodiment of the voice-based customer interaction subsystem 120. The method 400 begins at step 402 where the customer initiates the voice-based interaction by, for example, calling a customer support telephone number.

The method 400 then proceeds to step 404 where the inbound customer communication is handled by the telephony interface logic module 307. This step may also include conveying an initial standard greeting and possibly presenting the customer with a set of initial options, such as a choice of languages. This will be handled by the voice exception process of the voice command vocabulary module 305 as described above. Once the greeting has been conveyed and the customers response to any initial questions has been noted, the method 400 proceeds to step 406.

At step 406, the knowledge tree is queried by the knowledge tree traversal logic module 301. If this is the beginning of the customer interaction, the root node will be queried. For example, in the exemplary knowledge tree 200 of FIG. 2, the ‘Incident’ node would be queried.

At step 408, the information associated with the queried node is returned to the knowledge tree traversal logic module 301. This information will include information about the node itself, such as whether or not the node is a leaf node, and possible language parameters. If the node is a leaf node then the information associated with that node, such as a customer solution, is also returned to the knowledge tree traversal logic module 301. If the node is not a leaf node then information about the children of the queried node is returned.

At step 410, the knowledge tree parser module 302 determines whether a list of child nodes was returned at step 408 and, if so, checks the size of the returned dataset against its business logic rules to determine if the information can be presented within the boundaries of the list presentation limit. If the number of child nodes is greater than the list presentation limit, then the list will be divided into chunks which are each smaller than the limit. The list presentation limit is set in order to ensure that too many options are not presented at once, which may be confusing to the customer. Limiting the lists presented to the customer to, for example, ten items or less also ensures that the customer may select an option with a single key press where the interaction is through a standard telephone. This parsed data, as well as any other node information received in step 408, is then forwarded to the language rules module 303.

At step 412, the language rules module 303 checks that the language contained in the language parameters for the queried node is supported. As mentioned above, the database may contain any number of knowledge trees. Each knowledge tree can be constructed in any language, and each branch or node of a knowledge tree could potentially be in any language. The language rules module 303 contains a defined list of supported languages. If the language contained in the language parameters for the queried node is not a supported language then an error code could be generated and an appropriate error handling routine would be initiated. This will be handled by the voice exception process of the voice command vocabulary module 305, as described above. Alternatively, the language rules module 303 could revert to a default language such as English.

At step 414, the information received from the language rules module 303 will be converted into an appropriate text stream by the language interpreter 304. All formatting, such as HTML formatting, and other information which may have been relevant to other types of systems, such as for the visual presentation of data in a web based system, is converted into appropriate spoken descriptions. The end result is a text stream which is appropriate for the information being described. If the queried node is a leaf node then the text stream will be a spoken representation of the information contained in the node. If the queried node is not a leaf node, then this text stream may be in the form of one or more multiple choice questions. The options presented in these multiple choice questions should correspond to the child nodes of the node queried in step 406.

If the number of child nodes queried in step 406 exceeds the list presentation limits described above, the options may have to be presented in more than one multiple choice question. This could be accomplished, for example, by providing the user with the first nine options and then allowing the user to press a specific key or state a specific word for more options. Alternatively, the user could be allowed to issue a “maybe” command each time they hear an option which may be appropriate. In this embodiment, a temporary cache could be used to store the options which have been selected as possibly appropriate. After hearing all of the options, the user would then be presented with the subset list of selected options.

At decision diamond 416, the method 400 determines whether the node queried in step 406 was a leaf node. If so, the method 400 proceeds to step 418 where the information contained in the queried node, such as the potential solution to a customer's problem, is processed by the voice presentation layer module 306 and presented to the customer by the telephony logic module 307. The customer interaction may then end or, alternatively, the customer may be given other options such as speaking to an agent or repeating the process for the same issue or for a new issue.

If the node queried in step 406 was not a leaf node then the method 400 continues to step 420 where the multiple choice question(s) created by the spoken language interpreter 304 are processed by the voice presentation layer module 306 and presented to the customer by the telephony logic module 307.

The voice browser module 132 then waits for a response from the customer. This response may be, for example, in the form of a DTMF key press or other manual entry or it may be in the form of a word or phrase spoken by the customer. At step 422, the customer response is captured by the telephony interface logic module 307 and relayed to the knowledge tree traversal logic module 301 to be used in determining which node to query next. The method 400 then returns to step 406 and the process repeats for the next queried node.

While the method described above uses a simple strategy for traversing the knowledge tree, it would be understood by those skilled in the art that there may be other methods for traversing a non-binary tree using, for example, more advanced heuristics or weighting of the nodes of the tree.

While what has been shown and described herein constitutes some exemplary embodiments of the present invention and while some variations of the embodiment have also been described, it should be understood that various modifications and adaptations of such embodiments can be made without departing from the present invention, the scope of which is defined in the appended claims.

1. A voice-based customer interaction system for interacting with a customer based on data contained in one or more knowledge trees, the system comprising:
a) a tree traversal module adapted to query the one or more knowledge trees for requested data;
b) a knowledge tree parser adapted to transform the requested data according to one or more business logic rules;
c) a language interpreter adapted to convert the transformed data into a text stream; and
d) a voice presentation module adapted to verbally present the text stream to the customer and accept a customer response,
wherein, the data contained in the one or more knowledge trees is not stored as audio data.

2. The system of claim 1, wherein the data is stored in a web browser readable format.

3. The system of claim 1, wherein the customer response comprises one or more dual-tone multi-frequency key presses.

4. The system of claim 1, wherein the customer response comprises a word or phrase spoken by the customer.

5. The system of claim 1, wherein the tree traversal module is further adapted to return one or more child nodes of a queried node and the queried node is based on a previous customer response.

6. The system of claim 5, wherein the language interpreter is further adapted to form a multiple choice question based on the one or more child nodes of the queried node.

7. The system of claim 6, wherein the one or more business logic rules comprises a list presentation limit and the knowledge tree parser is further adapted to, when the number of the one or more child nodes of the queried node is greater than the predetermined list presentation limit, parse the child nodes of the queried node into two or more sets of child nodes, the number of child nodes in each set being less than the predetermined list presentation limit.

8. The system of claim 7, wherein the language interpreter is further adapted to form two or more multiple choice questions based on the two or more sets of child nodes.

9. The system of claim 1, wherein the tree traversal module is further adapted to query a new knowledge tree upon receiving the location of the new knowledge tree.

10. The system of claim 1, the system further comprising a language rules module adapted to check the language of the requested data against a list of supported languages and to generate an error code if the language of the requested data does not appear on the list of supported languages.

11. A method of interacting with a customer using automated voice communication, the method comprising:
a) querying one or more knowledge trees for requested data;
b) transforming the requested data according to one or more business logic rules;
c) converting the transformed data into a text stream;
d) presenting the text stream to the customer using voice communication;
e) receiving a response from the customer;
f) repeating steps a) to e) until a leaf node of the one or more knowledge trees is reached at step a); and
g) presenting information contained in the leaf node to the customer using voice communication,
wherein, the data contained in the one or more knowledge trees is not stored as audio data.

12. The method of claim 11, wherein the data is stored in a web browser readable format.

13. The method of claim 11, wherein the customer response comprises one or more dual-tone multi-frequency key presses.

14. The method of claim 11, wherein the customer response comprises a word or phrase spoken by the customer.

15. The method of claim 11, wherein step a) comprises returning one or more child nodes of a queried node based on a previous customer response.

16. The method of claim 15, wherein step c) comprises forming a multiple choice question based on the one or more child nodes of the queried node.

17. The method of claim 16, wherein the one or more business logic rules comprises a list presentation limit and step b) further comprises, when the number of the one or more child nodes of the queried node is greater than the predetermined list presentation limit, parsing the child nodes of the queried node into two or more sets of child nodes, the number of child nodes in each set being less than the predetermined list presentation limit.

18. The method of claim 17, wherein step c) further comprises forming two or more multiple choice questions based on the two or more sets of child nodes.

19. The method of claim 11, the method further comprising checking the language of the requested data against a list of supported languages and generating an error code if the language of the requested data does not appear on the list of supported languages.

20. A customer interaction system, the system comprising:
a) a database adapted for storing one or more generic knowledge trees;
b) a web-based customer interaction system adapted for interacting with a customer via the Internet based on data contained in the one or more knowledge trees; and
c) a voice-based customer interaction system adapted for interacting with a customer using automated voice communication based on data contained in the one or more knowledge trees, the system comprising:
i) a tree traversal module adapted to query the one or more knowledge trees for requested data;
ii) a knowledge tree parser adapted to transform the requested data according to one or more business logic rules;
iii) a language interpreter adapted to convert the transformed data into a text stream;
iv) a voice presentation module adapted to verbally present the text stream to the customer and accept a customer response.
